(19) United States
(12) Patent Application Publication
(10) Pub. No.: US 2003/0072368 A1
(43) Pub. Date: Apr. 17, 2003

(54) Selectively protecting motion information of multimedia data

(76) Inventors: Joseph C. Chan, San Diego, CA (US); Koji Kimura, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/978,619

(22) Filed: Oct. 15, 2001

(51) Int. Cl. H04N 7/12

(52) U.S. Cl. 375/240.12; 375/240.27; 375/240.24

(57) ABSTRACT

A method and system for selectively protecting motion information of multimedia data. The multimedia data is initially examined to determine whether the motion information of the current multimedia data unit is lost or corrupted. The multimedia data is then examined to determine whether the motion information is important enough to adversely affect reliable prediction of that information if that the motion information of the current multimedia data unit is lost or corrupted. The motion information is selectively protected if the motion information is determined to be important enough.

### BACKGROUND

The present invention relates to multimedia data, and more particularly, to selectively protecting motion information of multimedia data.

In an MPEG-4 decoder used for real-time streaming, when texture information is lost or corrupted, motion compensated temporal replacement may be an appropriate error concealment technique for video frames without much scene changes. The technique uses motion information to propagate texture from the previous frame to replace the corrupted texture in the current frame. Thus, this technique may provide effective error concealment as long as motion information can be obtained without much error. However, when the motion information is lost or corrupted, the information may be predicted using average or median of motion information from neighboring uncorrupted macroblocks. This technique is simple but sometimes yields inadequate performance if the actual motion information of neighboring macroblocks differs. Moreover, if the predicted motion information is substantially different from the actual motion information, effective error concealment may not be possible.

### SUMMARY

In one aspect, a method is disclosed which includes determining whether motion information of a current multimedia data unit is lost or corrupted. The method then determines whether the motion information is important enough to adversely affect reliable prediction of the motion information if that motion information of the current multimedia data unit is lost or corrupted. The motion information is selectively protected if the motion information is determined to be important enough.

In another aspect, a motion information protection system for multimedia data is disclosed. The system includes a prediction error cost calculator, a selector, and a processor. The prediction error cost calculator provides a motion information prediction error cost for each multimedia data unit. The selector selects a first number of multimedia data units in a frame of multimedia data having highest motion information prediction error cost. The processor processes motion information of each multimedia data unit, and provides protection for the motion information, if a current multimedia data unit is in the first number of multimedia data units.

### BRIEF DESCRIPTION OF THE DRAWINGS

FIGS. 1A and 1B illustrate a method for selectively protecting motion information of multimedia data according to an embodiment of the present invention.

FIG. 2 is a block diagram of a motion information protection system for multimedia data according to an embodiment of the present invention.

### DETAILED DESCRIPTION

In recognition of the above-stated difficulties with the prior error concealment techniques in cases where motion information is lost or corrupted, the present invention describes embodiments for selectively protecting motion information of multimedia data, which may include information, such as video, audio, text and other sensory information. Moreover, the multimedia data may use compression schemes, such as Moving Picture Experts Group 2 (MPEG-2) or MPEG-4. The selective protection of motion information may include additional protection for certain motion information, which if lost or corrupted would adversely affect the decoders ability to reliably predict or conceal the corrupted information. Consequently for purposes of illustration and not for purposes of limitation, the exemplary embodiments of the invention are described in a manner consistent with such use, though clearly the invention is not so limited.

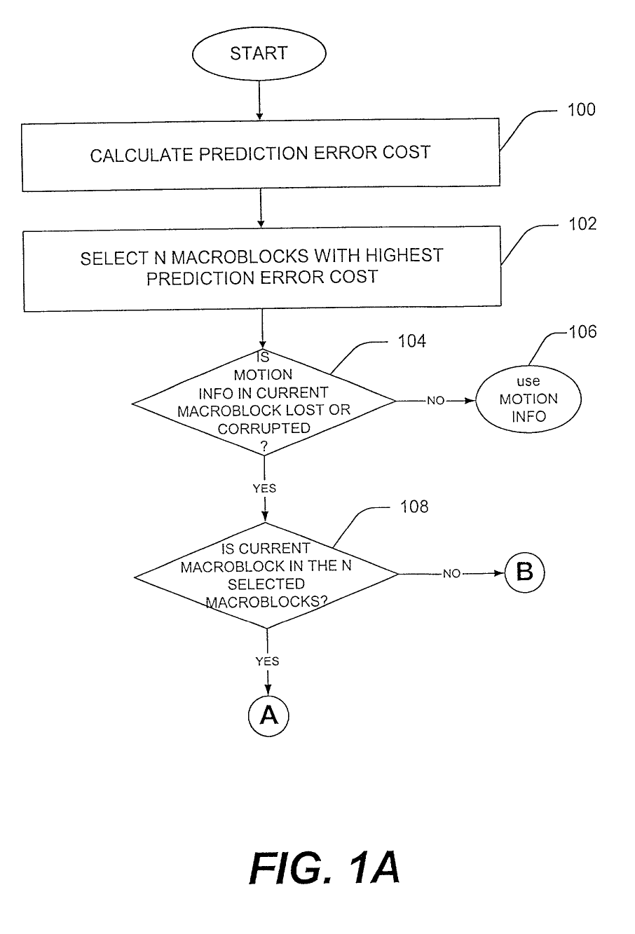

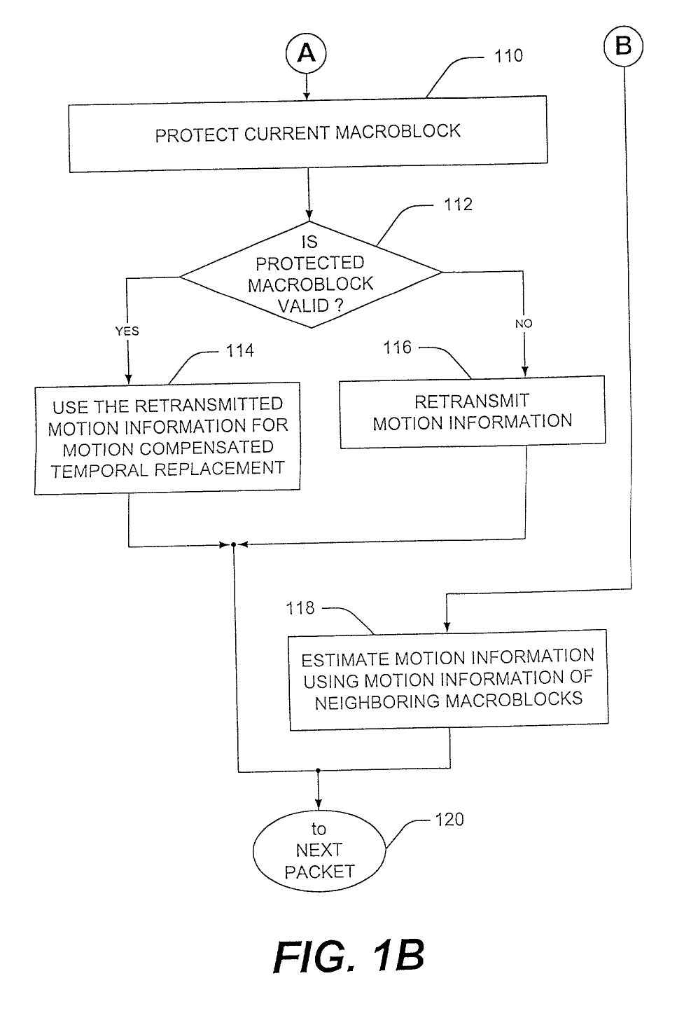

A method for selectively protecting motion information of multimedia data according to an embodiment of the present invention is illustrated in FIGS. 1A and 1B as a flowchart. The method includes calculating a motion information prediction error cost for each macroblock, at 100. This prediction error cost indicates the degree to which the corrupted information may adversely affect the decoder's ability to provide reliable prediction or concealment. Therefore, the higher the prediction error cost, the greater the adverse effect on the decoder's ability to provide reliable prediction.

In one embodiment, the prediction error cost of the motion information may be calculated, at the encoder, as magnitude difference between the predicted motion vector and the actual motion vector of the macroblock. As mentioned above, the motion vector may be predicted using average or median of motion vectors from neighboring macroblocks. In another embodiment, the prediction error cost may be calculated, at the encoder, as sum of the magnitude difference between the actual motion vector of the macroblock and the motion vectors of neighboring macroblocks.

In the above-mentioned embodiments, the prediction error cost should be calculated (at the encoder) in a substantially similar way as motion information would be estimated at the decoder. Thus, this provides more accurate measure of adverse effect of the corrupted motion information on the decoder's ability to provide reliable prediction.

Once the motion information prediction error cost has been calculated, a first number of macroblocks (N) with the highest prediction error cost is selected, at 102. This selection enables protection of motion information for those macroblocks that are substantially different from neighboring macroblocks. Furthermore, the first number of macroblocks (N) may vary with anticipated error rate in the channel (between the encoder and the decoder). Hence, the amount of motion information that is protected may depend on the channel error rate to achieve best overall multimedia quality at the decoder. In some embodiments, the first number of macroblocks (N) at different bit rates and bit error rates may be determined empirically in advance. In other embodiments, the value for N may be dynamically selected.

A determination is then made (at 104) as to whether the motion information in the current macroblock is lost or corrupted. If the motion information is not lost or corrupted, the motion information may be used (at 106) to conceal or predict texture data. Otherwise, if the motion information is lost or corrupted, a determination is made (at 108) as to whether the current macroblock is in the selected first number of macroblocks (N). If the current macroblock is in the selected first number of macroblocks (N), it indicates that the motion information in the current macroblock is considered to be important enough to be protected because the corrupted motion information may adversely affect the decoder's ability to provide reliable prediction or concealment. Therefore, if the current macroblock is in the selected first number of macroblocks (N), the motion information in the current macroblock is protected, at 110. In some embodiments, the current macroblock may be protected by retransmitting the macroblock. In other embodiments, the current macroblock may be protected by reconstituting the macroblock using any practicable means.

The protected macroblock is examined, at 112, to determine if the macroblock is valid. In one embodiment, the validity of the macroblock may be determined by verifying the Protection Cyclic Redundancy Check (CRC) in the packet. If the retransmitted or reconstituted macroblock is valid, the retransmitted or reconstituted motion information is used to calculate the motion compensated temporal replacement of the texture data, at 114. Otherwise, if the retransmitted or reconstituted motion information is not valid, the retransmission or reconstitution is repeated, at 116.

Otherwise, if the current macroblock is not in the selected first number of macroblocks (N), and the motion information is lost or corrupted, the motion information of the current macroblock may be obtained in a usual manner. This includes estimating the motion information of the current macroblock using motion information of neighboring macroblocks, at 118. The next multimedia packet is processed at 120.

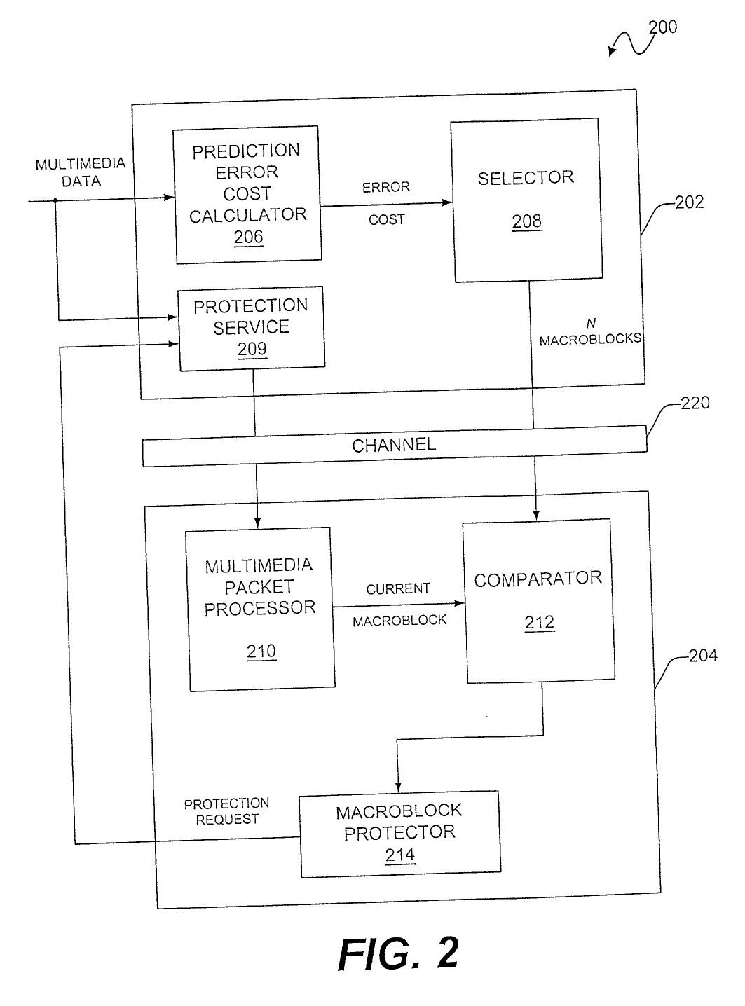

FIG. 2 is a block diagram of a motion information protection system 200 for multimedia data according to an embodiment of the present invention. In the illustrated embodiment, the system 200 encompasses both the encoder 202 and the decoder 204. Thus, the system 200 includes a prediction error cost calculator 206, a selector 208, and a protection service element 209, in the encoder 202. The system also includes a multimedia packet processor 210, a comparator 212, and a macroblock protector 214, in the decoder 204.

The prediction error cost calculator 206 receives packets of multimedia data and calculates a motion information prediction error cost for each macroblock of the multimedia packet. As stated above, this prediction error cost indicates the degree to which the corrupted information may adversely affect the decoder's ability to provide reliable prediction or concealment. The prediction error cost is then sent to the selector 208 where a certain number of macroblocks (N) with the highest prediction error cost is selected. This information is subsequently sent to the decoder 204.

The multimedia packet processor 210 in the decoder 204 receives the multimedia data stream from the channel 220, and processes macroblocks in each multimedia packet. The current macroblock is processed to determine whether the motion information in the current macroblock is lost or corrupted. If the motion information is not lost or corrupted, the motion information may be used to conceal or predict texture data. Otherwise, if the motion information is lost or corrupted, the current macroblock is sent to the comparator.

The current macroblock is examined in the comparator 212 to determine if the current macroblock is in the list of N macroblocks to be protected. If the comparator 212 determines that the current macroblock is in the list, the comparator directs the macroblock protector 214 to issue a protection request. The issuance of the protection request by the macroblock protector 214 is sent to the protection service element 209. In the illustrated embodiment, the service element 209 is in the encoder 202. But in other embodiments, the service element 209 may be in the decoder 204. The protection service element 209 may operate to protect the current macroblock by retransmitting the macroblock. The current macroblock may also be protected by reconstituting the macroblock using any practicable means.

There has been disclosed herein embodiment for selectively protecting motion information of multimedia data. Motion vectors of the multimedia macroblocks are provide with added protection, such as retransmission, to ensure reliable prediction. Hence, if the macroblock is lost or corrupted, and this macroblock is deemed to be “important”, the motion information in the macroblock is protected.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, although the method and system for selectively protecting motion information is described as processing the motion information in units of macroblocks, other multimedia data units may be used. Other multimedia data units may include audio or meta-data blocks or frames. In other instances, well-known structures and functions were not described in elaborate detail in order to avoid obscuring the subject matter of the present invention. Accordingly, the scope and spirit of the invention should be judged in terms of the claims which follow.

What is claimed is:

1. A method, comprising:
first determining whether motion information of a current multimedia data unit is lost or corrupted;
second determining whether said motion information is important enough to adversely affect reliable prediction of said motion information if said motion information of said current multimedia data unit is lost or corrupted; and
selectively protecting said motion information if said motion information is determined to be important enough.

2. The method of claim 1, wherein said current multimedia data unit is a macroblock within a frame of multimedia data.

3. The method of claim 2, wherein said second determining includes calculating prediction error cost for each macroblock in the frame.

4. The method of claim 3, further comprising:
selecting a first number of macroblocks with highest prediction error cost.

5. The method of claim 4, wherein said selecting a first number of macroblocks includes adjusting said first number of macroblocks in proportion to an anticipated error rate in a communication channel between an encoder and a decoder.

6. The method of claim 4, wherein said selecting a first number of macroblocks includes empirically determining in advance said first number of macroblocks according to different bit rates and bit error rates.

7. The method of claim 4, wherein said selecting a first number of macroblocks includes dynamically adjusting said first number of macroblocks according to different bit rates and bit error rates.

8. The method of claim 1, wherein said selectively protecting said motion information includes issuing commands to retransmit said motion information.

9. The method of claim 1, wherein said selectively protecting said motion information includes reconstituting said motion information.

10. A method for selectively protecting motion information of multimedia data units, comprising:
calculating a prediction error cost;
selecting a first number of multimedia data units with highest prediction error costs; and
protecting a current multimedia data unit, if the motion information of said current multimedia data unit is lost or corrupted, and if said current multimedia data unit is in the first number of multimedia data units.

11. The method of claim 10, further comprising:
determining whether the protected current multimedia data unit is valid.

12. The method of claim 11, further comprising:
using the motion information of the protected current multimedia data unit for motion compensated temporal replacement if the protected current multimedia data unit is valid.

13. The method of claim 11, further comprising:
issuing a command to perform another protection of said current multimedia data unit, if the protected current multimedia data unit is invalid.

14. The method of claim 10, wherein said multimedia data units are macroblocks in a frame of multimedia data.

15. The method of claim 10, wherein said calculating a prediction error cost includes computing a magnitude difference between predicted motion information and the actual motion actual motion information of the current multimedia data unit.

16. The method of claim 15, wherein the predicted motion information is computed using average of motion information from neighboring multimedia data units.

17. The method of claim 10, wherein said calculating a prediction error cost includes computing sum of a magnitude difference between actual motion information of the current multimedia data unit and motion information of neighboring multimedia data units.

18. The method of claim 10, wherein said protecting a current multimedia data unit includes retransmitting the current multimedia data unit.

19. The method of claim 10, wherein said protecting a current multimedia data unit includes reconstituting the current multimedia data unit.

20. A motion information protection system for multimedia data, comprising:
a prediction error cost calculator to provide a motion information prediction error cost for each multimedia data unit;
a selector to select a first number of multimedia data units in a frame of multimedia data having highest motion information prediction error cost; and
a processor to process motion information of said each multimedia data unit, said processor to provide protection for said motion information, if a current multimedia data unit is in the first number of multimedia data units.

21. The system of claim 20, further comprising:
a comparator to determine if the current multimedia data unit is in the first number of multimedia data units.

22. The system of claim 21, further comprising:
a macroblock protector to issue a protection request when the comparator determines that the current multimedia data unit is in the first number of multimedia data units.

23. The system of claim 22, further comprising:
a protection service element to provide protection for the motion information of the current multimedia when the macroblock protector is sues the protection request.
